(19) United States
(12) Patent Application Publication
(10) Pub. No.: US 2026/0127731 A1
(43) Pub. Date: May 7, 2026

(54) SYSTEMS AND METHODS FOR MPS-GAN: A MULTI-CONDITIONAL GENERATIVE ADVERSARIAL NETWORK FOR SIMULATING INPUT PARAMETERS' IMPACT ON MANUFACTURING PROCESSES

(71) Applicants: Shenghan Guo, Gilbert, AZ (US); Hasnaa Ouidadi, Tempe, AZ (US)

(72) Inventors: Shenghan Guo, Gilbert, AZ (US); Hasnaa Ouidadi, Tempe, AZ (US)

(73) Assignee: Arizona Board of Regents on Behalf of Arizona State University, Tempe, AZ (US)

(21) Appl. No.: 19/383,425

(22) Filed: Nov. 7, 2025

Related U.S. Application Data
(60) Provisional application No. 63/717,768, filed on Nov. 7, 2024.

(51) Int. Cl. G06T 7/00; G06T 12/20; G06V 10/34; G06V 10/40; G06V 10/764; G06V 10/774; G06V 10/776; G06V 10/82

(52) U.S. Cl. CPC G06T 7/001; G06T 12/20; G06V 10/34; G06V 10/40; G06V 10/764; G06V 10/7747; G06V 10/776; G06V 10/82; G06T 2207/10081; G06T 2207/20081; G06T 2207/20084; G06T 2207/30136; G06T 2207/30144; G06T 2207/30168; G06T 2211/441; G06V 2201/06

(57) ABSTRACT

A system for assessing and simulating the impact of processing parameters on the final quality of a manufacturing product is disclosed. The system includes a multi-parameter simulation generative adversarial network that uses a generator module and a discriminator module. The generator module is modified such that it can synthesize realistic images from multiple processing parameters and the discriminator module is modified such that it can evaluate the synthesized and training images for their realness and predict the multiple processing parameters used for the images. In order to allow for the production of high-resolution images the system can also use a judge module to assess the perceptual quality of the synthesized images.

### CROSS REFERENCE TO RELATED APPLICATIONS

The present document is a Non-Provisional patent application that claims benefit to U.S. Provisional Patent Application Ser. No. 63/717,768 filed Nov. 7, 2024, which is herein incorporated by reference in its entirety.

### FIELD

The present disclosure generally relates to generative adversarial networks, and more specifically to the use of a multi-parameter simulation generative adversarial network to simulate the effect of processing parameters on a manufactured product.

### BACKGROUND

Quality is a crucial criterion in manufacturing that ensures the adherence of built products to the specifications set by the designer and their proper functioning when put into operation. An important factor influencing products' quality is the combination of process (or build) parameters used during the manufacturing process. The choice of these build conditions is crucial to the success or failure of manufacturing a particular product and thus needs to be planned both thoughtfully and efficiently. However, identifying the optimal build parameters requires considerate trial-and-error experiments, which is associated with high labor and material costs. One practical way to control and optimize experimental testing will be to adopt statistical analysis such as design of experiments (DOE). DOE enables the quantification of the inputs-output relationship and helps investigate the potential effect of multiple input factors (i.e., build parameters) on a particular outcome (i.e., final product's quality). Nevertheless, this approach still requires a large experimental effort, especially since no generalizable protocol exists to guide practitioners in finding the correct and optimal design among all the possible ones.

Another potential solution would be to “virtually” analyze the different possible scenarios (based on input parameters) through simulation. Most simulation efforts to study the influence of build parameters are based on finite-element analysis (FEA). This technique provides an approximate solution to physics-based equations governing the phenomena occurring during the studied process. Due to its outstanding performance, FEA has been adopted in many engineering disciplines and applications to analyze phenomena such as structural mechanics, electric and magnetic fields, heat transfer, and fluid dynamics. Nevertheless, the use of this approach can also come with some disadvantages. First, the solutions provided by FEA are only approximative. Second, this method may not always capture the intricate interconnection between different mechanical-thermal and other physical behaviors taking place during the manufacturing process, which can sometimes lead to erroneous results. In addition, using FEA is challenging as it requires deep knowledge and understanding of physics laws, coding, and the different commands involved in the FEA software. Finally, these FEA simulations are expensive as they necessitate mighty computational power and may take a long time for convergence.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1 depicts images representing the influence of increasing current intensity when joining two boron steel sheets.

FIG. 2 depicts images representing the influence of the number of sheets and the coating state when using the “EXP” current intensity.

FIG. 3 depicts images representing the CoCr AM XCT dataset for different scan speed (v_scan) and hatch spacing (h_spacing).

FIG. 4 is a schematic of the MPS-GAN for generating the RSW images.

FIG. 5 is a schematic of the MPS-GAN generator's architecture.

FIG. 6 is a schematic of the MPS-GAN discriminator's architecture.

FIG. 7 is a comparison between real images of thermal weld nugget taken form the RSW dataset and images generated by the MPS-GAN for each combination of parameters.

FIG. 8 is a comparison between real XCT images taken from the training dataset, images generated using the MPS-GAN, and images generated using the MPS-GAN-IR for each combination of parameters.

FIG. 9 is a block diagram of a computer-implemented system suitable for implementing the multi-parameter simulation generative adversarial network according to embodiments disclosed herein.

Corresponding reference characters indicate corresponding elements among the view of the drawings. The headings used in the figures do not limit the scope of the claims.

### DETAILED DESCRIPTION

The present disclosure relates to example systems and methods for assessing the impact of processing parameters on the final quality of a manufactured product through the use of a multi-parameter simulation generative adversarial network (MPS-GAN). In one example, an inventive concept includes a generative adversarial network GAN configured for identifying optimal build parameters. In general, a GAN model synthesizes unrealistic images with a close probabilistic distribution to training images, and examples of the GAN model described herein can include a GAN model architecture named Multi-Parameter Simulation GAN (MPS-GAN) that combines thermal and X-ray computed tomography (XCT) images, which generate images constrained by predefined characteristics. The results can be used by manufacturers to gain a representative image of the products' quality by identifying optimal build parameters. In some examples, MPS-GAN accommodates synthesization of plausible thermal and X-ray computed tomography (XCT) images representing different manufacturing processes, and can accommodate image-generation across a plurality of parameters. Example implementations of MPS-GAN and MPS-GAN-IR was tested on datasets from two different manufacturing process—resistance spot welding and additive manufacturing. Visual and numerical results show that MPS-GAN and MPS-GAN-IR can be good alternatives to experimental tests and physics simulations (e.g., FEA).

Identifying the right combination of process parameters is crucial to ensure a high quality of the manufactured products. Nevertheless, this task is not always straightforward, as it usually requires a lot of experimental trials and a deep understanding of the physical laws governing the process. The present disclosure presents an efficient way of dealing with this problem using a generative adversarial network (GAN) model. The proposed Multi-Parameter Simulation GAN (MPS-GAN) model can synthesize thermal and X-ray computed tomography (XCT) images conditioned on different combinations of build parameters. The study also proposes a model variant, named MPS-GAN-IR, that uses the content loss to generate large images with improved perceptual quality and resolution. The performance of the MPS-GAN and MPS-GAN-IR was tested on real datasets taken from two different manufacturing processes, mainly resistance spot welding and additive manufacturing. The image-generation capability of both models was also evaluated for various combinations of build parameters for each process. The “quality measure” for each process was considered to provide a quantitative evaluation of the models' performance. The visual and numerical results indicate that the MPS-GAN and MPS-GAN-IR models could be a viable alternative to experimental tests and physics-based simulations.

Nowadays, with the advent of artificial intelligence (AI), especially generative AI, it becomes evident to manufacturers to leverage these techniques to alleviate and improve the predictions obtained from simulations. When combined with AI, simulation can predict anomalies and problems before they can occur in a real physical system. Therefore, in the case of manufacturing processes, AI-driven simulation will be a relatively inexpensive and more convenient way to create a practical testing set-up to investigate the influence of different input parameters in the resulting part's quality. An AI model that can efficiently accomplish this simulation task is called generative adversarial network (GAN). GAN is a well-established generative deep learning model that has been adopted for image, video, text, and time-series generation in a wide variety of applications like manufacturing, healthcare, arts, animation, etc. GANs are a special type of generative AI models that synthesize unrealistic images with a close probabilistic distribution to the training images. The merits of GAN models and their potential to integrate auxiliary information (i.e., conditions) make them a good candidate for assessing the influence of different combinations of process parameters on the final quality and characteristics of manufactured parts.

The present disclosure proposes a novel GAN model architecture named Multi-Parameter Simulation GAN (MPS-GAN). This network can synthesize plausible thermal and X-ray computed tomography (XCT) images representing different manufacturing processes. The advantage of the MPS-GAN is its ability to generate images constrained by predefined characteristics (i.e., multiple combinations of building parameters). By using this model, manufacturers can obtain a representative image of the quality state of a specific product by only providing the combination of process parameters. The proposed model is very practical as it allows a preliminary assessment of the influence of build parameters without having to run experiments or deal with the underlying physical phenomena governing the studied manufacturing process. The current version of the MPS-GAN model can allow image-generation constrained on three distinct build parameters. The present disclosure also presents an innovative approach for improving large images' (256×256) perceptual quality and resolution. This is very important when dealing with microscopic imaging like XCT, which usually exhibit extremely tiny details and features that are important to characterize the quality and properties of the build components.

The influence of build parameters on the final product quality will be simulated for two different manufacturing processes. The first process is called resistance spot welding (RSW). RSW is a joining process that consists of exerting a pressure between two or more thin sheets using electrodes and then applying an electrical current that generates a resistance heat. The produced heat melts a localized portion of the material that forms a thermal weld nugget and joins the stacked sheets together. This welding method offers numerous advantages in terms of low cost, efficiency, and good quality. In addition, it accommodates a wide range of metallic materials and alloys like aluminum, steel, titanium, etc. As a result, it is used in various high-tech industries like automobile, aerospace, railway, and medical. In average, a car may contain up to 6000 resistance welding spots. Therefore, the condition of those welds is very crucial for the overall structural integrity of the vehicle. The second process that will be considered in the present disclosure is additive manufacturing (AM). AM consists of building samples in a layer-by-layer fashion based on a 3D CAD model. This manufacturing process presents many advantages in terms of performance, weight, and ease of fabricating intricate and complex shapes. AM is increasingly being adopted in various applications such as aerospace, automotive, medicine, etc. As a result, the quality of additively manufactured parts needs to adhere to the specifications required in these high-tech applications.

The organization of the disclosure is as follows. The Literature Review section will explain the theory behind GANs and present some important variants based on which the MPS-GAN was developed. This section will also summarize previous studies that have used GANs for manufacturing applications. The Data Description section will introduce the two manufacturing datasets that will be used in this study. The Model Development section will detail the development of the MPS-GAN model and explain the approach adopted for improving image quality and resolution (MPS-GAN-IR) in the case of generating large-sized images. The Results and Discussion section will show the visual results of applying the MPS-GAN and MPS-GAN-IR for generating images from the two datasets and explain how the model can simulate the impact of different combinations of building parameters. The Quantitative Evaluation of the MPS-GAN and MPS-GAN-IR Models section will present the quantitative results of both the MPS-GAN and MPS-GAN-IR using the “quality metric” corresponding to each simulated manufacturing process. Finally, the Conclusion section will conclude the work and highlight the future directions of this study.

### Literature Review

This section presents an overview of generative adversarial networks (GANs) and some of their variants based on which the MPS-GAN model was developed. State-of-the-art papers that have previously adopted GAN models for surrogate modeling and the evaluation of input parameters' effect on manufacturing quality will also be discussed.

### Generative Adversarial Networks (GANs)

The generative adversarial network (GAN), developed by Goodfellow et al., is a type of generative AI models commonly used for image-generation. The architecture of a GAN consists of two parts: 1) The generator takes data points from a latent space (i.e., random noise) and generates implausible images, and 2) The discriminator tries to distinguish between the fake images generated by the generator and some real (i.e., training) images that are being fed to it. The image-generation is achieved by simultaneously training the generator and discriminator parts of the GAN model through minimax optimization with the objective function V(D, G) as shown in Eq. (1). During this process, the discriminator is trained to accurately classify the incoming images as “fake” or “real”. In contrast, the generator is trained to produce almost realistic images that will delude the discriminator and lead to a wrong classification. For this purpose, the generator is trained to capture the probability distribution of the real images and learn the right mapping to convert data points from the latent space to images that are close to the real ones. However, this learning is solely achieved through the feedback (whether generated images are correctly classified as “fake”) obtained from the discriminator part. In fact, there is no direct connection between the generator and the real images. Therefore, the generator's performance highly depends on the discriminatory power of the discriminator.

$${min}_{G} {max}_{D} V ( D , G ) = {E}_{x ∼ {P}_{data} ( x )} [ log D ( x ) ] + {E}_{z ∼ {P}_{z} ( z )} [ log ( 1 - D ( G ( z ) ) ) ] \qquad ( 1 )$$

In its initial release (i.e., Vanilla GAN), the GAN model's generator and discriminator were designed as multilayer perceptrons with trainable weights ⊖_{g} and ⊖_{d}, respectively. The generator tries to capture the appropriate mapping (G(z)) that transforms data points drawn from the input latent vector z into plausible images with distribution P_{g}. The discriminator tries to distinguish between the real and fake incoming images (x) and returns probability D(x) or D(G(z)) depending on whether the image x is coming from the training data distribution P_{data}(x) or generated data distribution P_{g}. During the training process, the parameters ⊖_{d} are tuned so that the discriminator maximizes [log(D(x)+log(1 D(G(z))], leading to an accurate classification of the training and generated images, while the parameters ⊖_{g} are adjusted so that the generator minimizes log(1 D(G(z)) by producing almost plausible images that will mislead the discriminator.

Even though the Vanilla GAN was a breakthrough in generative AI, the synthesized images were noisy, and the model suffered from training stability issues. Therefore, Radford et al. attempted to replace the multilayer perceptron architecture used for both generator and discriminator with a new architecture based on convolutional layers, leading to the deep convolutional GAN (DCGAN). Through their architecture composed of a sequence of convolutional layers and max pooling layers, convolutional neural networks (CNNs) can automatically extract fine features from images and thus lead to improved classification and detection performance. By leveraging the topology of CNNs, DCGAN provided many improvements to the Vanilla GAN regarding training stability and image-generation with much better quality and resolution. Nevertheless, another issue remained. Both the Vanilla GAN and DCGAN models provided no control over the generated images. In this sense, a well-trained generator will just randomly produce images with similar distribution as the training data. This is not really efficient since the user will require the generated images to have some specific characteristics and modalities in most cases.

The conditioning of the GAN model can be obtained by constraining the image-generation on some specific “class”. This was achieved through the conditional generative adversarial network (cGAN) introduced by Mirza et al. To account for the training images' mode (i. e., class), the generator and discriminator of the cGAN model take two inputs rather than just one. The class label “y” of the training data is fed as an additional input to both parts of the model, and the objective function is adjusted to accommodate the extra condition (see Eq. (2)). This supplementary constraint aids in controlling the outcome of the cGAN model and provides restrictions over the generated images.

$${min}_{G} {max}_{D} V ( D , G ) = {E}_{x ∼ {P}_{data} ( x )} [ log D ( x \vert y ) ] + {E}_{z ∼ {P}_{z} ( z )} [ log ( 1 - D ( G ( z \vert y ) ) ) ] \qquad ( 2 )$$

The conditioning of GAN models can go beyond a simple scalar label “y” since many researchers have controlled the generated images using text descriptions (i.e., stackGAN) and also images (i.e., image-to-image GAN).

### GAN Models for High-Resolution Image-Generation

Generating high-resolution images has always been a concern within the GAN community. Most of the initial versions of GAN models were constrained to generate low-resolution images (up to 64×64). Only adding layers to up-sample and increasing the size of the generated images led to poor-quality images and induced stability issues during training. Nevertheless, some researchers were able to synthesize high-resolution images by introducing novel designs to the conventional GAN's architecture. This section presents some previous efforts to achieve high-resolution image-generation for conditioned and unconditioned GANs.

Regarding conditioned GAN, Odena et al. introduced the auxiliary classifier GAN (AC-GAN) model (A. Odena, C. Olah, and J. Shlens, “Conditional image synthesis with auxiliary classifier GANs,” arXiv:1610.09585v4, 2017, incorporated herein by reference in its entirety). The AC-GAN can synthesize higher resolution (126×126) and globally coherent images, which was not possible using its predecessors. This was achieved by adding an auxiliary classifier to the discriminator. When implementing the AC-GAN, the class labels are only provided to the generator, while the discriminator only gets the incoming images as input. Therefore, the job of the discriminator in the AC-GAN is not only to evaluate the realness (real/fake) of the incoming data but also to predict their adequate class (label). Zhang et al. proposed the stackGAN, a model that produced 256×256 photo-realistic images conditioned on text descriptions. According to Zhang et al., generating images based on sentences is by itself a challenging task since the generator part of the GAN sometimes fails to capture the tiny details in the description (i.e., eyes, noise; in the case of generating birds' images). This task becomes even more intricate when generating high-resolution images (256×256). To overcome this problem, the StackGAN consists of two different stacked models each representing a single stage of the image-generation process. First, the Stage I model generates low-resolution (64×64) images that capture the rough meaning of the text description and include some low-level details like the objects' shape and colors. These low-resolution images are then fed along with their respective descriptions to the Stage II model that synthesizes plausible photo-realistic images with increased resolution (256×256) and more refined details.

The super-resolution GAN (SR-GAN) is an image-to-image model that was specifically designed to convert low-resolution images to their high-resolution equivalent with a (4×) upscaling factor. In this sense, the images produced by the SRGAN can be 4× larger than their original counterpart. In addition to the increased size, the model generates images with a much better resolution and a successful recovery of the fine textural details. This high-quality image-generation is achieved through the combination of a deep residual network architecture of the SR-GAN model and a novel loss function. Unlike the previously discussed GANs for which the image reconstruction is solely based on the adversarial loss Eq. (1), the SR-GAN is optimized using the perceptual loss which combines the adversarial loss and the content loss. The content loss is calculated based on a pre-trained VGG-19 model and was introduced to improve the perceptual similarity between the generated and training images. More details about the content loss will be provided in the Loss Function Modification for High-Resolution Image-Generation section.

Karras et al., introduced the progressive growing GAN (Pro-GAN), a model that produced photo-realistic images going up to a size of 1024×1024 pixels. The idea behind ProGAN was to create a model that starts by learning low-scale features in low-resolution (4×4) images and gradually grows to generate very high-resolution images (1024×1024). At the beginning of the training, the discriminator is provided with 4×4 images while the generator learns to generate low-resolution images of the same size. Once the generator learns the representation of the rough details present in these low-resolution images, the architecture of the generator and discriminator gets expanded by adding more layers to each. This adjustment enables them to process 8×8 images in the subsequent training round. The same process continues and the model keeps on gradually growing (16×16, 32×32, etc.) until reaching an architecture able to produce 1024×1024 images. By adopting this growing architecture for both the generator and discriminator components, the ProGAN successfully synthesizes very high-resolution and sharp images in a faster and more stable training process.

### Applications of GAN Models in Manufacturing Processes

From the literature, it was found that the predominant usage of GAN models in manufacturing is for “data augmentation” purposes. Data augmentation involves synthesizing new unrealistic samples to increase the available data. This is important for training image classification deep learning (DL) models. With the increased popularity of AI models for defect detection and quality assessment of manufacturing processes, it became essential to have a tremendously large dataset to ensure proper model training and avoid overfitting. Nevertheless, gathering sufficient data is costly and sometimes impossible for certain manufacturing processes. For instance, due to the extensive efforts achieved in quality improvements and the use of techniques such as Six Sigma, images (and other data) of defective items are very scarce since most of the manufactured items are healthy. Nevertheless, this lack of defective items' images causes a data imbalance which can be detrimental to the performance of classification or fault detection DL models. In addition, traditional transformation techniques such as geometric and color augmentation (i.e., image cropping, rotation, scaling, and addition of noise) are not suitable for all types of images. Therefore, synthesizing new samples representative of the available training dataset (i.e., defective items) becomes crucial to improve classification models' performance. Due to their outstanding image-generation capabilities, GANs are considered a powerful and efficient solution for supplementing more training data instances and many studies have demonstrated their ability to improve classification models' accuracy.

In addition to data augmentation, GANs have been adopted as surrogate models to simulate the effect of build parameters used in manufacturing processes. Guo et al. developed the LMDcGAN model to predict the transient thermal signature of the melt pool region in laser metal deposition (LMD)-based AM processes. The developed model synthesizes 128×128 melt pool images constrained by the layer index used during the deposition process. The LMDcGAN was also used to predict the thermal distribution of future melt pool images based on the current index layer of an unfinished part. This was achieved through the integration of an encoder network that converts the melt pool image of the current layer index (I) into a latent vector. The latter is fed to the generator along with a defined upcoming layer index (I+i) to generate the melt pool image corresponding to that specific layer before it gets deposited. Zhu et al. developed the Parameters-to-Temperature GAN (PTGAN) model for producing 256×256 images depicting the thermal profile of an armored vehicle under different thermal parameters (i.e., thermal conductivity, solar absorptivity, and surface emissivity). During the model training, these three conditions were fed to the generator as a single text description. To improve the generated images' quality, the model adopted a joint loss function. Iyer et al. developed an auxiliary classifier Wasserstein GAN with gradient penalty (ACWGAN-GP) to simulate the influence of the cooling method on the microstructure features of ultrahigh carbon steel alloy. The 128×128 micrographs used for training the model were taken from the UHCS database. Five different heat treatment conditions, i.e., no heat treatment, quenching, furnace cooling, air cooling and constant heating at 650 C for 1 Hour, were used to control the image-generation of the developed ACWGAN-GP model. Similarly, Howland et al. developed a multi-conditional ACWGAN-GP to generate scanning electron microscopy (SEM) images. The synthesized SEM images reflect the microscopic topology of aluminum alloy AA7075 tubes that were fabricated through the “shear-assisted processing and extrusion” manufacturing technique. Two different GANs were trained, each conditioned on a set of two parameters. The first GAN was conditioned on the temper or heat treatment condition (T5 vs. T6) and the ultimate tensile strength range (low, mid, high), while the second model was conditioned on the temper (T5 vs. T6) and the range of feed rate used during the manufacturing process (low, mid, high). The generated SEM images were also 128×128 in size. Muclari et al. developed the Gated Recurrent Unit GAN (GRU-GAN) model to simulate the weld penetration; a phenomenon that occurs underneath the workpiece and which has a tremendous effect on the observable behaviors that happen on the topside face of the workpiece as the welding process goes on. Characterizing these observable behaviors based on penetration is crucial to enhance real-time adaptive adjustment of robotic welding technology. The GRU-GAN model was conditioned on the backside images (i.e., penetration) to generate topside images of the workpiece (i.e., observable behavior). The conditioning of the GRU-GAN model was based on a sequence of 8 consecutive images of the workpiece backside images. The use of the gated recurrent unit (GRU) in the generator's architecture was to explicitly account for the timing and order of the images and thus provide a more accurate representation of the weld penetration history and dynamics. The proposed GRU-GAN model was shown to enhance the image-generation process when compared to using a simple cGAN model conditioned on an array formed by the 8 consecutive fed all at once as a block to the generator. The image-generation of the GRU-GAN model was further improved by incorporating the welding current as an extra condition to the generator. The visual and numerical results showed that this additional condition led to an improved image-generation of the topside images of the workpiece. Therefore, it was concluded that the observable behaviors seen on the topside of the workpiece are a result of the coupling of the arc welding current and penetration dynamics taking place on the backside of the workpiece.

The present disclosure proposes the Multi-Parameter Simulation GAN (MPS-GAN) model, a novel variant of the AC-GAN model, able to synthesize plausible images representing different manufacturing processes. The MPS-GAN is capable of generating images conditioned on different combinations of up to three input parameters at a time. Depending on the manufacturing process analyzed and the type of inspection methods available, the generated images can be microscopic, XCT, thermal images, etc. In addition to image-generation constrained by different processing parameters, this study also proposes the MPS-GAN for improved resolution (MPS-GAN-IR) that integrates the content loss to improve the perceptual quality and resolution of large images (256×256). Even though the content loss approach was inspired by the SR-GAN model, this study still holds its novelty. First, the MPS-GAN-IR starts image-generation from a latent space rather than a low-resolution image, which already contains low-level details and rough features representative of the objects in the training data. Therefore, the weighting factor (w) of the content loss was gradually adjusted during the training process so that the generator is first familiarized with the probabilistic distribution of the training images corresponding to each combination of process parameters before attempting to produce high-quality images. In addition, unlike other generative models that used the content loss for improving the quality of the generated images, the MPS-GAN-IR is conditioned on multiple combinations of processing parameters and uses an external judging model (i.e., pre-trained VGG-19) for feature extraction and content loss calculation. As a result, the real and generated images fed to the VGG-19 model during each batch must be associated with the exact same set of build parameters. This consistency is crucial to enable a correct learning of the different high-level features characterizing each combination of process parameters present in the training dataset. Nevertheless, unlike the discriminator (commonly used in other conditioned GANs), the pre-trained VGG-19 used with the MPS-GAN-IR lacks prior information about the connection between the incoming images and their associated set of process parameters. Therefore, a search mechanism was added to retrieve real images with the same combination of build parameters as those of the generated images during each batch. This will enable the comparison of feature maps extracted from real and generated images that both correspond to the same combination of print parameters, enabling a correct and quicker improvement of the perceptual quality of the generated images. Finally, the present disclosure used the MPS-GAN to analyze the effect of process parameters on the final quality characteristics of two manufacturing processes, i.e., RSW and AM, each having distinct geometrical patterns and levels of detail. This will show the generalization of the proposed model.

### Data Description

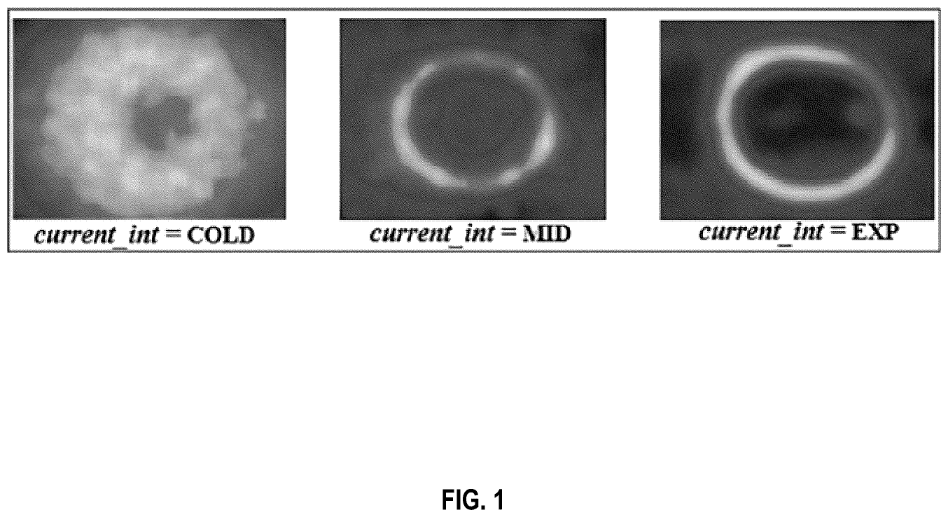

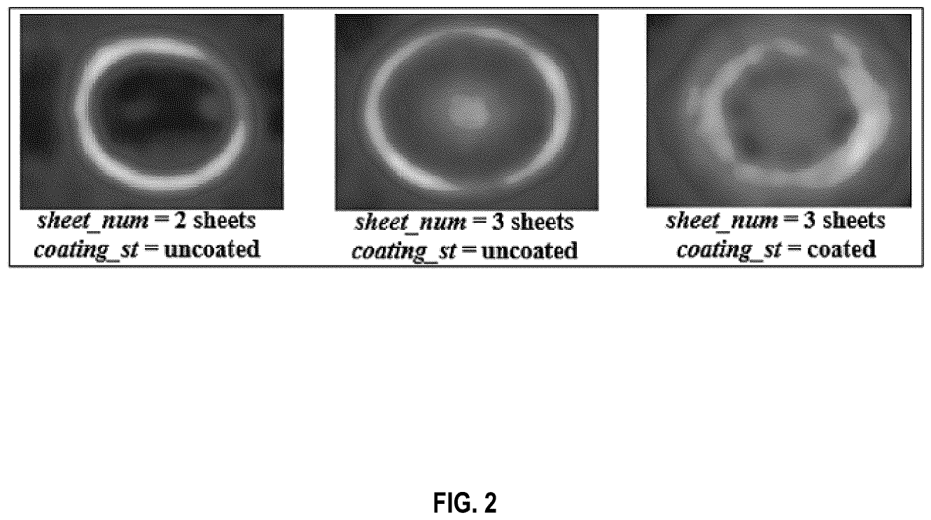

Two datasets from distinct manufacturing processes will be analyzed as part of the present disclosure to demonstrate the image-generation performance and generalization of the proposed MPS-GAN model. The first dataset depicts the RSW process of boron steel sheets performed at the Oak Ridge National Laboratory (ORNL). The dataset consists of 61×81 gray-scale thermal images that capture the formation of the thermal weld nugget as a response to different applied current intensities (current_int). In addition, two other build parameters were considered in the welding process, mainly the number of sheets joined together (sheet_-num) and the coating state (coating_st). The latter means whether the metallic sheets were coated with a thin aluminum layer before being joined or not. For analysis purposes, the thermal images were reshaped to 64×64. FIG. 1 shows the influence of increasing current intensity on the final shape of the thermal weld nugget. FIG. 2 depicts the change in thermal weld nugget shape as a response to varying the number of metallic sheets joined together and the coating state.

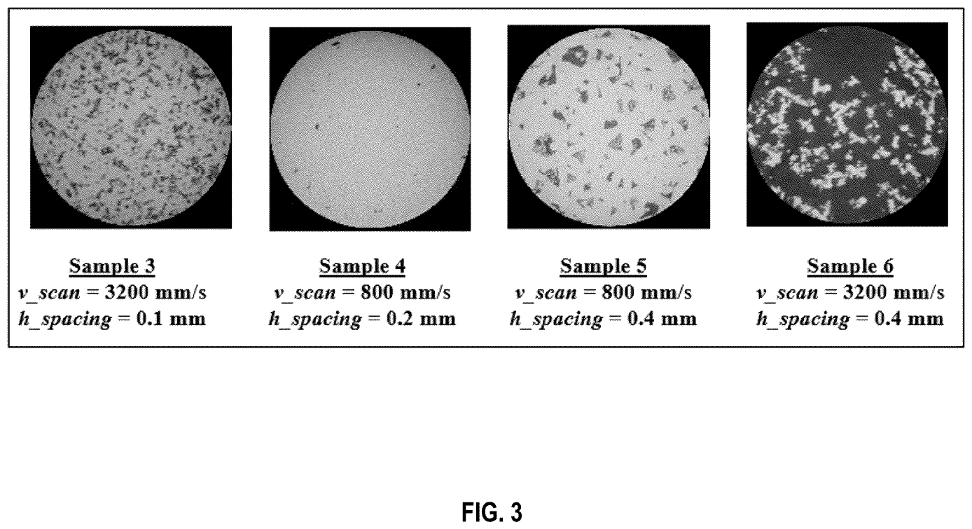

The second dataset represents XCT images of additively manufactured CoCr specimens obtained from the National Institute of Standards and Technology (NIST). These samples were fabricated using different combinations of scan speed (v_scan) and hatch spacing (h_spacing). FIG. 3 presents XCT images that represent the defect morphology for each sample and, thus, combination of processing parameters. The size of the XCT images is different for each sample therefore, all images were resized to 256×256 in this analysis.

### Model Development

This section presents the steps for developing the Multi-Parameter Simulation GAN (MPS-GAN) model. The architecture of the MPS-GAN is based on the AC-GAN model, which was modified to account for different conditions during image-generation. This section also explains the steps for integrating the content loss to the model's loss function in order to improve the perceptual quality and resolution of large images.

The choice of the AC-GAN as a base model for developing the MPS-GAN was based on two main considerations. First, the AC-GAN is an improved version of the cGAN model that integrates an auxiliary classifier to discriminate between the class labels of the real and generated images instead of providing the class labels directly to the discriminator (i.e., like in the case with cGAN). This auxiliary classifier offers many advantages in terms of improved quality, coherence, and resolution of the generated images. It also enhances the model's stability. This is because the additional classification nature of the discriminator enables an improved learning of the dependencies between the training images and their corresponding class labels making the generator produce more realistic and classifiable images. This virtue of the auxiliary classifier also forces the generator to produce “conditioned” images in a more accurate fashion. Second, the classification ability of the AC-GAN model's discriminator allows the generator to learn disentangled representations of the numerous class labels present in the training dataset. In this manner, the generator starts to learn the different patterns that are more representative of each class label and accordingly generates high quality images that align better with their corresponding class modality (i.e., labels). This last virtue of the AC-GAN is very important for designing the MPS-GAN model since the ability of the AC-GAN to disentangle the different classes will make it more suitable for adopting multi-conditional image-generation when compared to the cGAN model. In this way, it becomes easy to model the discriminator as a multi-class CNN and provide the class labels to the generator as separate single conditions in addition to the latent vector.

### Multi-Conditioning of the AC-GAN

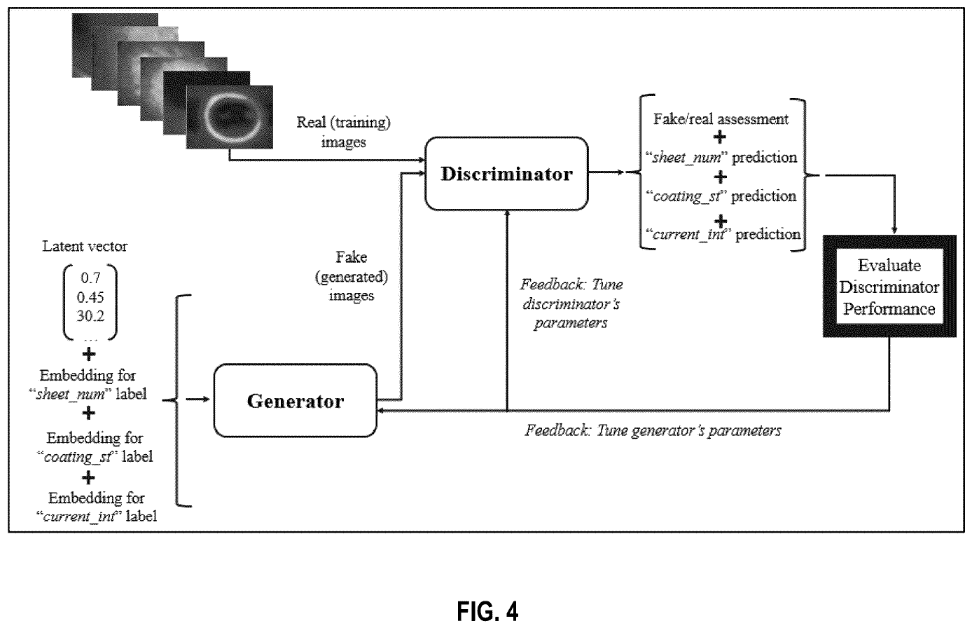

The first objective of this research is to develop a model able to generate plausible images that represent the quality of a manufactured product conditioned on different input processing parameters. Therefore, the first step was to modify the AC-GAN's design to accommodate different class labels (i.e., input parameters). This section elaborates on the development of the MPS-GAN model that can generate images conditioned on multiple conditions. FIG. 4 shows the schematic of the model when trained to generate the RSW images considering different combinations of the three build parameters (i.e., current_int, sheet_num, and coating_st).

To accommodate for the different possible combinations of input parameters in the studied manufacturing processes, the generator will receive multiple input labels in addition to the latent vector (z). Each single label (cᵢ) will correspond to a specific processing parameter. Considering that a manufacturing process can be achieved using n processing parameters (p), each of which can take on mi different values, the generator will receive n+1 inputs. These will include the latent vector (z) plus n single values (i.e., c₁, c₂, c₃, . . . , cₙ) each corresponding to a specific input parameter. As a result, the discriminator will be a multi-class classifier that will return n+1 output values. The first output will represent the realness of the incoming images (i.e., fake/real), while the remaining output values will constitute its assessment of the class value (cᵢ) for each input parameter (pᵢ) studied.

In this study, all class labels (cᵢs) were considered as discrete variables with values going from 0 to mᵢ (i.e., the total number of different values that can be taken by each condition cᵢ). This consideration was used to enable the model to accommodate different types of process conditions. It also simplified the labelling process during the training. In practice, the process parameters can be numerical (frequently, they are) or categorical. For example, the current_int label in the case of the RSW (FIG. 1) had categorical values mainly, “COLD”, “MID”, or “EXP”. Similarly, the coating_st label (FIG. 2) was categorized as either “coated” or “uncoated”. Besides, even when the label values are numerical, they may not necessarily be continuous but sometimes show as discrete values during data collection. For instance, the h_spacing condition (FIG. 3) used in the CoCr AM XCT dataset can take values of “0.1”, “0.2”, or “0.4”; which are not continuous. Finally, the discrete nature of the variables made it easy to implement the multi-conditions by considering the discriminator as a multi-class CNN.

Before being fed to the generator, each input class c; will be converted to an embedding layer and then reshaped to the adequate format. Embedding is a technique widely used in natural language processing to automatically convert a text into a one or higher-dimensional array of numerical features (i.e., weights) that best describe its meaning. When used in GANs and other DL models, the weights constituting the embedding layer are trainable and tuned as the training goes on. In the case of the MPS-GAN model, the embedding layer was used to convert each class label (cᵢ) to an array of trainable parameters.

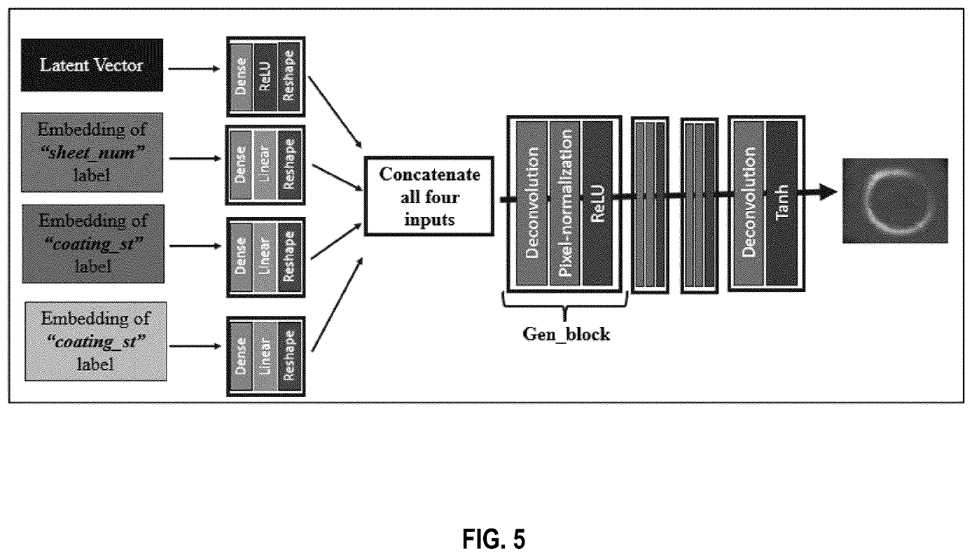

During the image-generation process, the generator converts a uniformly distributed 100-dimensional latent vector to an N_{final}·N_{final} image. To perform this conversion, the input latent vector is first reshaped to an (N_{final}·N_{final}) array by means of a dense layer. Here, f denotes the number of nodes used for the dense layer divided by (Nᵢₙᵢₜ·Nᵢₙᵢₜ). Also, the initial shape of the array (Nᵢₙᵢₜ) is smaller than the final size of the generated image (N_{final}). Similar to the latent vector, the n embedding layers representing the individual process input parameters (i.e., conditions) are all reshaped to an Nᵢₙᵢₜ·Nᵢₙᵢₜ·1 array and then concatenated with the reshaped latent vector. This forms an Nᵢₙᵢₜ·Nᵢₙᵢₜ(f+n) array which goes through a series of up-sampling blocks (Gen block), as shown in FIG. 5. The deconvolution (i.e., fractionally-strided convolutional) layers extract essential features from the input array and gradually expand its shape to higher dimensional arrays until reaching N_{final}·N_{final} sized image. Each deconvolution layer is followed by a pixel-normalization layer and then a rectified linear unit (ReLu) activation function with slope 0.2. The pixel-wise normalization was used to improve model stability during training. This technique consists of dividing each pixel value I_{x,y}, by the Euclidean norm of intensities taken from all N feature maps coinciding with that pixel location, as shown in Eq. (3). In this study, pixel-wise normalization was found to work best with the MPS-GAN when compared to batch normalization. Finally, the output layer of the generator was designed as a fractionally-strided convolutional layer followed by a Tanh activation function. FIG. 5 presents the structure of the generator used in the MPS-GAN while trained to generate the 64×64 thermal images taken from the RSW dataset.

$${I}_{{xy}_{normalized}} = {I}_{xy} / \sqrt{\frac{1}{N} {{\sum }_{i = 0}}^{N - 1} {( {I}_{xy}^{i} )}^{2} + {10}^{- 8}} \qquad ( 3 )$$

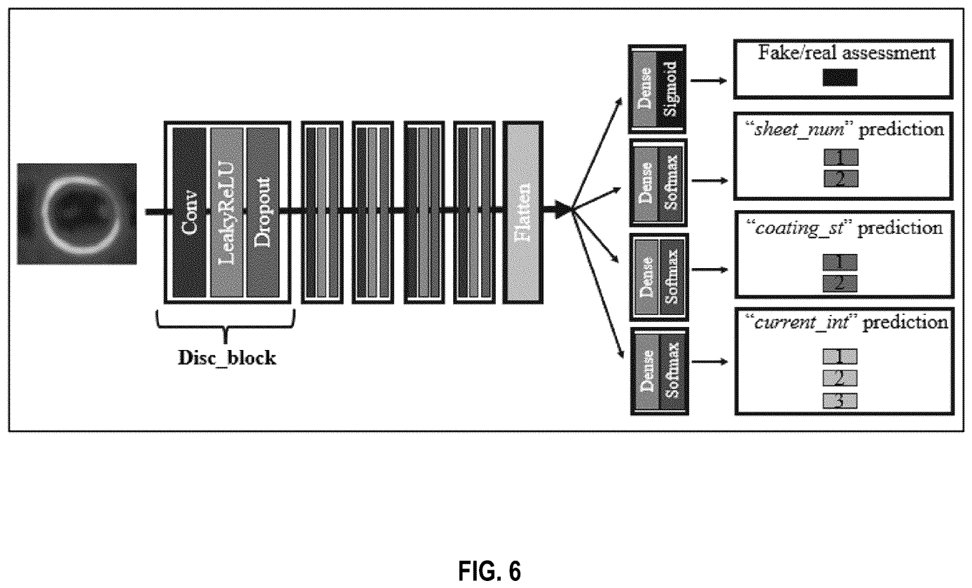

The discriminator of the MPS-GAN is modeled as a simple multi-class CNN with blocks (Disc block) constituted of convolutional layers with LeakyReLu activation function followed by a dropout layer as shown in FIG. 6. The rate of dropout was taken as 0.5, and this layer was added to overcome overfitting. The stack-up of convolutional layers automatically extracts critical features from the input images and gradually down-samples them into a low-dimensional feature map. The final feature map is flattened (i.e., converted to a vector) and then fed to n+1 different output dense layers. Similar to the Vanilla GAN, the first output layer is designed as a single-node dense layer with a Sigmoid activation function. The aim of this layer is to return the discriminator's assessment of the realness of the N_{final}·N_{final} incoming images and output either (“real:1”) or (“fake:0”). The remaining n output layers are multi-node dense layers with Softmax activation function. Each layer returns the probability assessment of each possible value (mᵢ) that can be taken by each input parameter (pᵢ) studied. The value m; with maximum probability will be taken as the final class prediction (cᵢ). The size (i.e., number of nodes) of each layer is equal to the number of possible values (mᵢ) that can be taken by each of the studied process parameters. FIG. 6 presents the structure of the discriminator used in the MPS-GAN while trained to generate the 64×64 thermal images taken from the RSW dataset. For this dataset, the sheet_num, and coating_st parameters have two (m1=m2=2) possible values each, while the current_int parameter can take up to three (m3=3) possible values. Table 1 summarizes additional details of the MPS-GAN architecture and hyperparameters used for generating images from (a) the RSW dataset, and (b) the CoCr AM XCT dataset.

TABLE 1
Parameters used for generating images from
the (a) RSW dataset, and (b) NIST dataset.

| | | (a) RSW | (b) CoCr AM |
|---|---|---|---|
| Dataset | | dataset | XCT dataset |
| Image shape | | 64 × 64 × 1 | 256 × 256 × 3 |
| Generator | Nᵢₙᵢₜ * Nᵢₙᵢₜ | 4 × 4 | 8 × 8 |
| structure | # of “Gen_block” | 3 | 4 |
| | used | | |
| | Kernel size | (5 × 5) | (5 × 5) |
| | Strides | (2 × 2) | (2 × 2) |
| | # of filters for | 384, 192, 256 | 384, 192, |
| | deconv layer in | | 256, 256 |
| | each block | | |
| | # of filters for | 1 | 3 |
| | last deconv layer | | |
| | Optimizer | Adam | Adam |
| | Optimizer's | η = 0.0002 | η = 0.0002 |
| | parameters | β₁ = 0.5 | β₁ = 0.5/β₁ = 0.6 |
| Discriminator | # of “Disr_block” | 4 | 5 |
| structure | used | | |
| | # of filters for | 128, 128, | 32, 64, 128, |
| | each conv layer | 128, 256 | 128, 256 |
| | Kernel size | (3 × 3) | (3 × 3) |
| | Strides | (2 × 2) | (2 × 2) |
| | Optimizer | Adam | Adam |
| | Optimizer's | η = 0.0002 | η = 0.0002 |
| | parameters | β₁ = 0.6 | β₁ = 0.6 |

Due to the auxiliary nature of the discriminator, the loss function of the MPS-GAN will consist of two components, the adversarial loss and the auxiliary loss. The adversarial component is similar to that of the conventional GAN and is calculated based on the minimax optimization function discussed in the Literature Review section. This loss represents the log-likelihood of the discriminator's assessment of images' (x) realness (i.e., either real or fake). On the other hand, the auxiliary loss will represent the log-likelihood of the discriminator's prediction of the label or class (cᵢ) for each incoming image. Therefore, the new loss function of the generator and discriminator will be represented by Eqs. (4) and (5), respectively:

$${L}_{G} = {\underbrace{- {E}_{z ∼ {P}_{z} ( z )} [ log ( 1 - D ( {x}_{fake} ) ) ] +}}_{{L}_{{G}_{adv}}} {\underbrace{{{\sum }_{i = 0}}^{n} E [ log ( Prob ( {C}_{i} ( {x}_{fake} ) = {C}_{i} \vert {x}_{fake} ) ) ]}}_{{L}_{{G}_{aux}}} \qquad ( 4 )$$

where, x_{fake}=G(z|c₁, . . . , cₙ) represents the generated (i.e., fake) images.

$${L}_{D} = \{ \begin{matrix}{\underbrace{{E}_{{x}_{real} ∼ {P}_{data ( {x}_{real} )}} [ log D ( {x}_{real} ) ]} +}_{{L}_{{D}_{adv}}} \\ {\underbrace{{{\sum }_{i = 0}}^{n} E [ log ( Prob ( {C}_{i} ( {x}_{real} ) = {C}_{i} \vert {x}_{real} ) ) ]} , if x = {x}_{real}}_{{L}_{{D}_{aux}}} \\ {\underbrace{{E}_{z ∼ {P}_{z} ( z )} [ log ( 1 - D ( {x}_{fake} ) ]}}_{{L}_{{D}_{adv}}} + \\ {\underbrace{{{\sum }_{i = 0}}^{n} E [ log ( Prob ( {C}_{i} ( {x}_{fake} ) = {C}_{i} \vert {x}_{fake} ) ) ]} , if x = {x}_{real}}_{{L}_{{D}_{aux}}}\end{matrix} \qquad ( 5 )$$

where, x denotes the incoming images, and the i index represents the multiple possible input parameters that can be considered when synthesizing the images.

During the training of the MPS-GAN model, the discriminator will attempt to maximize the likelihood of correctly distinguishing between fake and real images while still returning the correct label (cᵢ) for each image. Therefore, the discriminator will be trained to maximize Eq. (5). On the other hand, the generator will try to fool the discriminator by making it classify the generated images as “real”. Nevertheless, the generator will also try to augment the chances of having the discriminator correctly predict the class label (cᵢ) of the incoming images. As a result, the generator will be trained to maximize Eq. (4).

### Loss Function Modification for High-Resolution Image-Generation

During the training process of a GAN model, the generator does not directly observe the “real” images. Instead, it attempts to learn their representative probabilistic distribution based on the feedback it gets from the discrimination. This approach is effective when dealing with small-sized training images (i.e., 64×64 pixels or smaller). However, relying solely on the discriminator to guide the learning process of the generator and make it capture all the spatial-information present in the training data is sometimes insufficient when dealing with high-resolution images (i.e., 256×256 pixels or larger). This challenge is further exacerbated when the training images are highly detailed and exhibit intricate patterns.

Due to their relatively small size (64×64), the thermal images depicting the weld nugget shape were easily simulated using the MPS-GAN discussed in the Multi-Conditioning of the AC-GAN section, whose structure is presented in FIGS. 4, 5 and 6. Nevertheless, the XCT images representing the defects morphology as a response to varying scan speed and hatch spacing are (256×256) in size and the details they contain can hardly be synthesized using the MPS-GAN model without further modifications. This section presents an innovative approach for dealing with high-resolution images. This modified version was named MPS-GAN for improved resolution (MPS-GAN-IR).

To account for high-resolution image-generation, an extra evaluation mechanism, or “judge”, was added to the MPS-GAN to aid the learning process of its generator. Along with the discriminator, this additional judging component will provide more guidance to the generator and help it capture and learn both the low-level and high-level features in the training images. The main objective of this third-party evaluator will be to assess the perceptual quality of the generated images by comparing their features to those of images taken from the training dataset. Due to their extensive training on large datasets (i.e., ImageNet), pre-trained VGG-19 models possess a large ability to compare the features extracted from two different images and successfully judge whether they are perceptually close or not. As a result, a pre-trained VGG-19 model was considered as the additional evaluator to improve the generation process of the XCT images. The weights and parameters of the pre-trained VGG-19 model will stay unchanged during the training process of the MPS-GAN-IR. Also, only the first three blocks (i.e., the first 10 layers) were used during the feature extraction task. These layers were shown to be sufficient for ensuring a good assessment of the images' perceptual quality while requiring less computational effort and time.

Similar to the discriminator, the pre-trained VGG-19 model will receive both reference (i.e., real) and synthesized images during the training process of the MPS-GAN-IR. The content loss (L_{G}_{_{content}}) will be calculated for each batch of real and fake images. As shown in Eq. (6), this loss is equal to the mean-square error (MSE) between the feature maps of the “generated” images (φ_{i,j}(x_{fake})ₖᵢ) and those of the “reference” images (φ_{i,j}(x_{ref})kl). The obtained MSE score will be multiplied by a weighting factor (w) and then added to the adversarial and auxiliary losses obtained from the discriminator as shown in Eq. (7). In this way, the MPS-GAN-IR will account for the content loss L_{G}_{_{content}} when optimizing the parameters of the generator.

$${L}_{{G}_{content}} = \frac{1}{{{W}_{ij}}^{*} {H}_{ij}} {{\sum }_{k = 1}}^{{W}_{ij}} {{\sum }_{l = 1}}^{{H}_{ij}} {( {{ϕ}_{ij} ( {x}_{ref} \vert {c}_{1} , … , {c}_{n} )}_{k , l} - {ϕ}_{ij} ( {x}_{fake} \vert {c}_{1} , … , {c}_{n} ) )}^{2} \qquad ( 6 )$$

$${L}_{G} = [ {L}_{{G}_{adv}} + {L}_{{G}_{aux}} ] + {w}^{*} {L}_{{G}_{content}} \qquad ( 7 )$$

where, the W_{i,j} and H_{i,j} parameters represent the dimensions of the VGG-19's feature maps.

Unlike the generator of the SR-GAN model for which the input is a low-resolution image that already contains low-level details and rough spatial information, the generator of the MPS-GAN-IR starts its image-generation from scratch without any prior perception of the training data. Therefore, it will initially be trained using a loss function that primarily emphasizes the adversarial and auxiliary losses and gives minimum focus to the content loss. This process will ensure that the model starts producing images with probabilistic distribution roughly close to that of the training images before attempting to generate images with high perceptual quality. The progressive adjustment to the generated images' quality was achieved by attributing an adjustable weighting factor (w) to the content loss. The value of this factor will gradually increase as the training of the MPS-GAN-IR goes on. The weighting factor of the adversarial and auxiliary losses was kept constant at a value of 1 throughout the whole training process. Through this approach, the first few training epochs (i.e., iterations) were solely devoted to familiarizing the generator with the probabilistic distribution of the training images and low-level features of the “real” images. These initial iterations will help the generator learn a preliminary representation of the spatial patterns present in the training images for each combination of input process parameters. At this stage, the weighting factor of the content loss w was set to a very small value and kept constant for the first few epochs. Once the generator starts synthesizing images with rough features and attributes of the defect characteristics for each combination of the input classes, the w is increased by a factor of 10. This process is carried out for the rest of the training process.

Unlike other generative models that adopted the content loss, the image-generation of the proposed MPS-GAN-IR is conditioned on different class labels. In addition, the feature extraction and content loss calculation are performed by means of a third-party evaluator, VGG-19, which (unlike the discriminator used as feature extractor in Zhu et al.) has no prior information about the link between the incoming images and their corresponding set of print parameters. Consequently, the reference images that will be fed to the VGG-19 for calculating the content loss need to be associated with the same labels for both the v_scan and h_spacing parameters as the generated images. For this purpose, a search mechanism was added to ensure this consistency. This was achieved through a custom function whose objective was to read the label values for both v_scan and h_spacing provided to the generator during training and perform a greedy search through the whole training dataset to randomly select images with the same values of printing conditions. This function ensures that each batch of generated images is compared with real images representing the same combination of input parameters. Table 2 presents a pseudo-code of the training process of the MPS-GAN-IR.

### Results and Discussion

The image-generation performance of the developed MPS-GAN and MPS-GAN-IR was evaluated using the RSW and CoCr AM XCT datasets, respectively. First, the RSW dataset composed of 64×64 thermal images representative of the weld nugget's shape will be used to demonstrate the ability of the proposed MPS-GAN model in synthesizing images conditioned on three input parameters. Second, the MPS-GAN-IR performance for high-resolution image-generation will be evaluated using the 256×256 XCT images depicting the defects' morphology and distribution in response to changes in scan speed and hatch spacing.

### RSW Dataset: Image-Generation Conditioned on Three Input Parameters for Low-Resolution (64×64) Images

When simulating the thermal weld nugget shape generated during the RSW process, the number of sheets joined together (sheet_num), the current intensity (current_int), and the coating state (coating_st) were all considered as separate conditions for constraining the image-generation of the MPS-GAN model. In the experimental tests performed at ORNL, the welding process of the metallic sheets was performed using either two or three sheets. Therefore, the sheet_num class can have only two values either “2 T” for the case of two layers or “3 T” for the case of three layers. On the other hand, three current intensities (current_int) were considered in this study, “COLD”, “MID”, and “EXP”. Finally, the coating status (coating_st) was labelled as either “YES” when the joined sheets were coated with an extra aluminum layer or “NO” when no coating was added. In the RSW dataset, the coating was added only in the case of sheet_num=“3 T”.

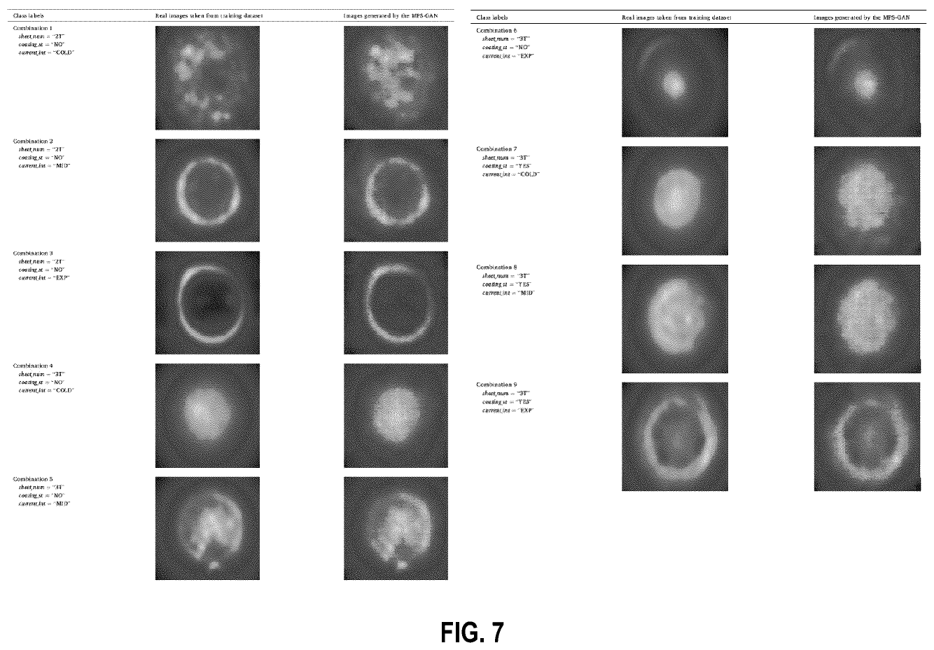

During the training of the MPS-GAN, each thermal image was given three label classes. In total 9 different combinations of build parameters were considered for the RSW dataset. The class labels were fed as extra input conditions to the generator along with the latent vector for image-generation. The training process was performed using 64 images from each combination and the model was trained for 150 epochs with a batch size of 16. FIG. 7 presents the results of the image-generation for each combination. These results show that the MPS-GAN model has successfully simulated the final shape of the thermal weld nugget for all 9 possible combinations of sheet_num, coating_st, and current_int build parameters. The generated images are almost identical to their corresponding real counterparts, which shows the potential of the MPS-GAN for multi-conditioned image-generation.

TABLE 2
Pseudo-code for training the MPS-GAN-IR.

```
Pseudo-code for training the MPS-GAN-IR
For each epoch (ep):
  Update the value of content loss weighting factor wand compile the GAN model For each batch of
  images (b):
  Train discriminator (D)
  Randomly select a batch of n real images (xᵣₑₐₗ) from the training dataset Calculate adversarial
  loss (L_{D}_{_{adv}}_real) and auxiliary loss (L_{D}_{ₐᵤₓ}_real) on Xᵣₑₐₗ
  Update the discriminator weights (W_{D}) on Xᵣₑₐₗ:
${W}_{D} = {W}_{D} - η \frac{d ( {L}_{{D}_{adv \_ real}} + {L}_{{D}_{aux \_ real}} )}{{dW}_{D}}$
  Generate n latent points [z, v_scan, h_spacing]; each constituted of a randomly generated
  latent vector (z) and a value for the v_scan and h_spacing labels
  Feed the n latent points [z, v_scan, h_spacing] to the generator (G) and generate a batch of n
  fake images x_{fake}
  Calculate adversarial loss (L_{D}_{_{adv}}_fake)and auxiliary loss (L_{Da}_{ᵤₓ}_fake) on x_{fake}:
${W}_{D} = {W}_{D} - η \frac{d ( {L}_{{D}_{adv \_ fake}} + {L}_{{D}_{aux \_ fake}} )}{{dW}_{D}}$
  Train generator (G)
  Generate new n latent points [z, v_scan, h_spacing]; each constituted of a randomly generated
  latent vector (z) and a value for the v_scan and h_spacing labels
  Read the generated values for labels v_scan and h_spacing and perform a greedy search
  through the whole training dataset to get a list I_{ref} of indices corresponding to the images
  having the same label values for v_scan and h_spacing
  Randomly select n indices from the list I_{ref} and retrieve their corresponding images; the latter
  will be taken as reference images for content loss calculation Feed the reference images to the
  pre-trained VGG-19 and calculate feature maps (φ_{i,j} x_{ref})_{k,l})
  Feed the n latent points [z, v_scan, h_spacing] to the generator (G) and generate a new batch
  of fake images x_{fake}
  Feed the fake images x_{fake} to the pre-trained VGG-19 and calculate feature maps (φ_{i,j} x_{fake})_{k,l})
  Calculate the content loss (L_{G}_{_{content}}).
${L}_{Gcontent} = MSE ( {{Φ}_{i , j} ( {x}_{ref} )}_{k , {l}^{′}} {{Φ}_{i , j} ( {x}_{fake} )}_{k , l} )$
  Feed the fake images X_{fake} to the discriminator and calculate their corresponding adversarial
  (L_{G}_{_{adv}}) and auxiliary loss (L_{G}_{ₐᵤₓ})
  Update the generator weights (W_{G}) on x_{fake}:
${W}_{G} = {W}_{G} - η \frac{d ( {L}_{{G}_{adv}} + {L}_{{G}_{aux}} + {L}_{{G}_{content}} )}{{dW}_{G}}$
```

### CoCr AM XCT Dataset: Image-Generation Conditioned on Two Input Parameters for High-Resolution (256×256) Images

For the CoCr AM XCT dataset, the defect morphology of each sample was analyzed as a response to two printing parameters, mainly the scan speed (v_scan) and the hatch spacing (h_spacing). As shown in FIG. 3, the v_scan variable can take on two values, “3200 mm/s” and “800 mm/s”. On the other hand, the h_spacing variables had three different values “0.1 mm”, “0.2 mm”, and “0.4 mm”. During the training of the MPS-GAN-IR, each XCT image was given two label classes and a total of 4 different combinations of printing parameters were considered for the CoCr AM XCT dataset. Again, the class labels were fed as extra input conditions to the generator along with the latent vector for image-generation. The training process was performed using 300 images from each combination and the model was trained for 150 epochs with a batch size of 16. The best perceptual quality of the generated images for the CoCr AM XCT dataset was achieved by setting the weighting factor of the content loss to w=10⁻⁴, for the first 15 epochs and subsequently increase it to 10⁻³ and 10⁻², once reaching epochs 30 and 45. Increasing the w value after this stage led to training instability and mode collapse. For this reason, its value was kept at 10⁻² for the remaining epochs. This weighting may differ depending on the properties and quality of the training images.

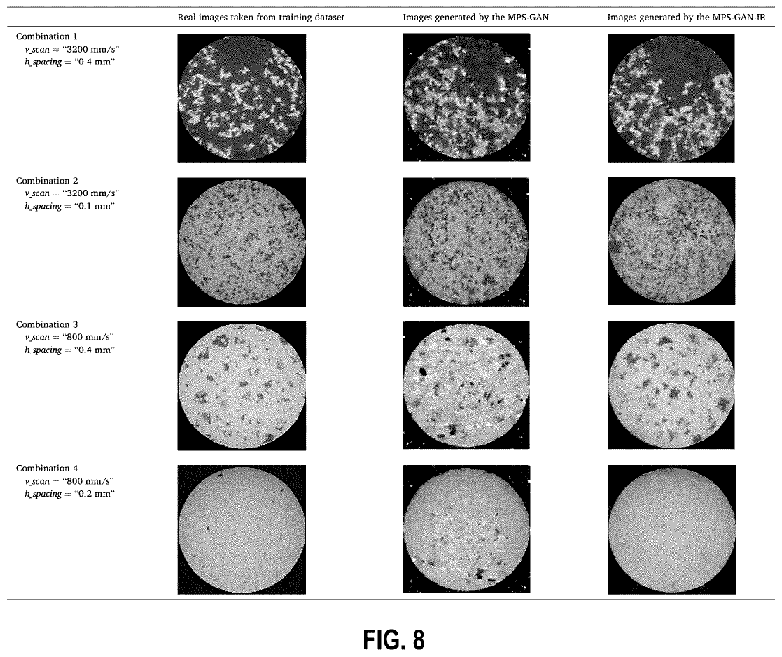

To assess the performance of the MPS-GAN-IR in improving the perceptual quality and resolution of the generated XCT images, its image-generation performance was compared to that of the MPS-GAN. FIG. 8 presents the results of the image-generation of the XCT images using both models. Visually, it can be clearly seen that the MPS-GAN-IR highly outperforms the MPS-GAN in synthesizing the XCT images for all 4 combinations of printing conditions. The MPS-GAN was only able to capture and successfully generate the low-level details of the defects. This was more evident for Samples 3 and 6, which contained large defects that were uniformly extended throughout the specimen's cross-section. Nevertheless, this model resulted in a poor image-generation performance for Samples 5 and 4, which contained smaller defects that were widely spread through the surface of the specimen. These results confirm that only adding more layers to the model's architecture is not an efficient way to generate high-resolution images and that more modifications to the loss function are needed. In fact, by accounting for the content loss, the generator of the MPS-GAN-IR was able to synthesize images that represent different characteristics of the training data for each input parameter combination with much improved quality and resolution compared to the MPS-GAN. The MPS-GAN-IR was able to successfully recover the fine details in its generated images that were missed by the MPS-GAN model. This improvement was more pronounced for Samples 5 and 4 whose defects' shape and details were sharp. For samples 3 and 6, the MPS-GAN-IR was able to enhance the clarity of the generated images, leading to less noisy and less blurry image-generation outcomes.

TABLE 3
Numerical comparison of the image-generation performance
of the MPS-GAN and MPS-GAN-IR on the CoCr AM XCT dataset.

| Metric | MPS-GAN | MPS-GAN-IR |
|---|---|---|
| Peak signal-to-noise ratio (PSNR) | 29.300 | 30.086 |
| Structural similarity (SSIM) | 0.276 | 0.420 |
| Frechet inception distance (FID) (×10³) | 98.197 | 24.511 |

The peak signal-to-noise ratio (PSNR), the structural similarity (SSIM), and the Fréchet inception distance (FID) scores were used as metrics to quantitatively compare the performance of both models. The PSNR measures the ratio of the maximum possible pixel intensity (i.e., 255 for 8-bit images) in the image to the MSE between the batch of real (xᵣₑₐₗ) and generated (x_{fake}) images. The larger the value of PSNR, the better the quality of the generated images. The SSIM presents a way to quantify the quality of images that correlates with humans' judgment. This metric compares the two batches of images in terms of luminance (l), contrast (c), and structural information (s). An image with good perceptual quality should have an SSIM value close to 1. Finally, the FID is another metric correlated to humans' perception, which evaluates the Fréchet (i.e., Wasserstein-2) distance between the Gaussian distribution of the features extracted from the real (xᵣₑₐₗ) and generated (x_{fake}) images. The smaller the Fréchet distance, the higher the similarity between the evaluated images. The formulas for calculating the PSNR, SSIM, and FID scores are shown in Eq. (8), Eq. (9), and Eq. (10), respectively. In these calculations, each batch of real and fake images comprised 100 images of size (M×N=256×256).

$$PSNR ( {x}_{real} , {x}_{fake} ) = 10 {{log}_{10}}^{*} \frac{{255}^{2}}{\frac{1}{{M}^{*} N} {\sum }_{x = 1}^{M} {\sum }_{y = 1}^{N} {( {x}_{real} - {x}_{fake} )}^{2}} \qquad ( 8 )$$

$$SSIM ( {x}_{real} , {x}_{fake} ) = {l ( {x}_{real} , {x}_{fake} )}^{*} c ( {x}_{real} , {x}_{fake} ) * s ( {x}_{real} , {x}_{fake} ) \qquad ( 9 )$$

$$FID ( {x}_{real {μ}_{1} , {\sum }_{1}} , {x}_{{fake}_{{μ}_{2} , {\sum }_{2}}} ) = {‖ {μ}_{1} - {μ}_{2} ‖}^{2} + Tr ( {\sum }_{1} + {\sum }_{2} - 2 {( {\sum }_{1} {\sum }_{2} )}^{1 / 2} ) \qquad ( 10 )$$

where, μ1, μ2 and Σ1, Σ2 represent the mean and covariance matrix of the Gaussian distribution of the feature maps corresponding to the real and generated images. Table 3 summarizes the scores obtained for each model.

The results in Table 3 show that the image-generation performance of the MPS-GAN-IR is superior to that of the MPS-GAN with a much smaller FID score and larger SSIM and PSNR values. These results also support the visual examples presented in FIG. 8 and confirm that the XCT images produced by the MPS-GAN-IR are perceptually closer to the original images taken from the training dataset. They justify the necessity of adding the content loss to the optimization process of the generator during model training. Nevertheless, even though the visual representations of XCT images generated by the MPS-GAN-IR for all four combinations of scan speed and hatch spacing are perceptually close to the original images, the corresponding large FID and small SSIM values elude that they are highly distinct. This phenomenon was also noticed in other studies where it was concluded that these metrics do not always correlate with human perception and judgment of image quality and similarity to the ground truth. For this reason, the performance of the MPS-GAN-IR model will be assessed by comparing the porosity content between the real and generated images to evaluate if the generated images are in conformance with the “quality” features found in the original dataset. These results will be discussed in the For The CoCr AM XCT Dataset section

### Quantitative Evaluation of the MPS-GAN and MPS-GAN-IR Models

The visual results in the Results and Discussion section shown in FIGS. 7 and 8 show the capability of the MPS-GAN and MPS-GAN-IR to synthesize plausible images conditioned on different parameters. The following section will present a quantitative evaluation for the image-generation performance of these two models. In the literature, numerically assessing the performance of a GAN model is not always straightforward since each metric has its own strength and limitations. This can also be noticed from the numerical results presented in Table 3. Therefore, the evaluation criteria for assessing the performance of the MPS-GAN and MPS-GAN-IR models on the RSW and CoCr AM XCT datasets was domain-driven in this study.

The main objective of this research was to help manufacturers in analyzing the effect of different combinations of build parameters on the final quality of their product. Therefore, the domain-specific “quality measure” for each process was considered to provide a quantitative evaluation for the image-generation performance of the proposed models.

### For the RSW Dataset

The quality of the thermal weld nugget formed during the RSW process can be deduced by its diameter. Therefore, this parameter was used as the main metric for evaluating the quality of the generated thermal images. To determine the diameter of the weld nugget for each combination of build parameters, the thermal images were first resized to their original dimensions (61×81) and segmented to isolate the weld nugget from the rest of the image. Contour detection was then performed, followed by fitting an ellipse to the detected contour. In this study, the weld nugget diameter was defined by the major and minor axes of the fitted ellipse. Table 4 compares the ellipse's major and minor axes and the orientation e for the real and generated images. Here, the major and minor axis length will be considered as the weld nugget diameters d1 and d2, respectively. In addition, a represents the orientation angle of the weld nugget with respect to the horizontal axis of the image. By evaluating the weld nugget parameters of the real images and those generated by the MPS-GAN, it can be seen that, except for combinations 5 and 9, the d1, d2, and ⊖ values are similar between the real and synthesized images for all combinations of build parameters. These results show that the MPS-GAN was able to reproduce thermal images that contain similar visual and geometrical characteristics of the weld nugget present in the original image taken by the thermal camera during the actual experiments.

TABLE 4
Comparison of the weld nugget's geometrical
parameters in both the real and generated images.

| | | Ellipse | |
|---|---|---|---|
| | Ellipse | parameters | |
| | parameters | for images | |
| Build parameters | for real | generated | |
| combination | images | by MPS-GAN | \|Error\| |
| Combination 1 | | | |
| sheet_num = “2T” | d₁ = 55.90 pixels | d₁ = 56.00 pixels | Δd₁ = 0.1 pixels |
| coating_st = “NO” | d₂ = 64.49 pixels | d₂ = 64.93 pixels | Δd₂ = 0.44 pixels |
| current_int = “COLD” | ⊖ = 110.67 deg | ⊖ = 109.15 deg | Δ⊖ = 1.52 deg |
| Combination 2 | | | |
| sheet_num = “2T” | d₁ = 43.21 pixels | d₁ = 42.92 pixels | Δd₁ = 0.29 pixels |
| coating_st = “NO” | d₂ = 51.38 pixels | d₂ = 53.86 pixels | Δd₂ = 2.48 pixels |
| current_int = “MID” | ⊖ = 94.64 deg | ⊖ = 96.08 deg | Δ⊖ = 1.44 deg |
| Combination 3 | | | |
| sheet_num = “2T” | d₁ = 44.73 pixels | d₁ = 46.22 pixels | Δd₁ = 1.49 pixels |
| coating_st = “NO” | d₂ = 51.08 pixels | d₂ = 50.41 pixels | Δd₂ = 0.67 pixels |
| current_int = “EXP” | ⊖ = 115.99 deg | ⊖ = 113.97 deg | Δ⊖ = 2.02 deg |
| Combination 4 | | | |
| sheet_num = “3T” | d₁ = 33.91 pixels | d₁ = 35.06 pixels | Δd₁ = 1.15 pixels |
| coating_st = “NO” | d₂ = 39.75 pixels | d₂ = 41.25 pixels | Δd₂ = 1.5 pixels |
| current_int = “COLD” | ⊖ = 97.35 deg | ⊖ = 76.58 deg | Δ⊖ = 20.77 deg |
| Combination 5 | | | |
| sheet_num = “3T” | d₁ = 50.72 pixels | d₁ = 45.56 pixels | Δd₁ = 5.16 pixels |
| coating_st = “NO” | d₂ = 59.41 pixels | d₂ = 52.84 pixels | Δd₂ = 6.57 pixels |
| current_int = “MID” | ⊖ = 90.02 degr | ⊖ = 77.02 deg | Δ⊖ = 13 deg |
| Combination 6 | | | |
| sheet_num = “3T” | d₁ = 22.12 pixels | d₁ = 23.44 pixels | Δd₁ = 1.32 pixels |
| coating_st = “NO” | d₂ = 28.26 pixels | d₂ = 29.40 pixels | Δd₂ = 1.14 pixels |
| current_int = “EXP” | ⊖ = 117.63 deg | ⊖ = 117.14 deg | Δ⊖ = 0.49 deg |
| Combination 7 | | | |
| sheet_num = “3T” | d₁ = 36.39 pixels | d₁ = 39.55 pixels | Δd₁ = 3.16 pixels |
| coating_st = “YES” | d₂ = 41.31 pixels | d₂ = 42.41 pixels | Δd₂ = 1.1 pixels |
| current_int = “COLD” | ⊖ = 71.40 deg | ⊖ = 91.28 deg | Δ⊖ = 19.88 deg |
| Combination 8 | | | |
| sheet_num = “3T” | d₁ = 44.62 pixels | d₁ = 44.03 pixels | Δd₁ = 0.59 pixels |
| coating_st = “YES” | d₂ = 47.35 pixels | d₂ = 48.10 pixels | Δd₂ = 0.75 pixels |
| current_int = “MID” | ⊖ = 78.60 deg | ⊖ = 70.42 deg | Δ⊖ = 8.18 deg |
| Combination 9 | | | |
| sheet_num = “3T” | d₁ = 59.93 pixels | d₁ = 48.22 pixels | Δd₁ = 11.71 pixels |
| coating_st = “YES” | d₂ = 64.93 pixels | d₂ = 63.47 pixels | Δd₂ = 1.46 pixels |
| current_int = “EXP” | ⊖ = 85.27 deg | ⊖ = 80.60 deg | Δ⊖ = 4.67 deg |

### For the CoCr AM XCT Dataset

XCT is performed to evaluate the porosity content of the manufactured specimens. Porosity content is proportional to a sample's mechanical properties, thus a crucial criterion for assessing its quality. To calculate the porosity content in each image, the XCT images were first binarized to separate the pixels corresponding to defective regions from those corresponding to the healthy material. The binarization resulted in images with only two pixel values, mainly 0 for the defect and 1 for the healthy material. Only the pixels within the circular region representing the specimen were considered for the calculation. The porosity content is equal to the ratio of the pixels denoting defects (pixel intensity=0) to that of the total number of pixels within the defined circular region. Due to its superior image-generation performance, only the MPS-GAN-IR was adopted in this part. Table 5 compares the porosity content obtained from the real and generated images for all four combinations of printing parameters.

By comparing the porosity content values between the original and generated images, it can be concluded that the proposed version of the MPS-GAN-IR provides a good assessment of the quality of the manufactured parts, since the porosity content value extracted from the generated images is very close to that of the original images. A slight difference was noticed for Sample 3 but this may be due to the large defect generated in the middle-left part of the specimen (FIG. 8). Nevertheless, these quantitative results once again support the visual representations presented in FIGS. 7 and 8 and confirm the potential of the proposed GAN models for providing a preliminary assessment of the effect of different combinations of build parameters on the quality of manufactured products.

TABLE 5
Porosity content comparison between real and generated images.

| | Porosity | Porosity content in | |
|---|---|---|---|
| Print parameters | content in | images generated by | |
| combination | real images | MPS-GAN-IR | \|Error\| |
| Combination 1 | 67.9% | 70.03% | 2.13% |
| v_scan = “3200 mm/s” | | | |
| h_spacing = “0.4 mm” | | | |
| Combination 2 | 17.13% | 23% | 5.87% |
| v_scan = “3200 mm/s” | | | |
| h_spacing = “0.1 mm” | | | |
| Combination 3 | 9.7% | 10.58% | 0.88% |
| v_scan = “800 mm/s” | | | |
| h_spacing = “0.4 mm” | | | |
| Combination 4 | 1.39% | 1.85% | 0.46% |
| v_scan = “800 mm/s” | | | |
| h_spacing = “0.2 mm” | | | |

### CONCLUSION

The present disclosure proposes a novel approach for assessing the effect of processing parameters on the final quality of a manufactured product. The Multi-Parameter Simulation GAN (MPS-GAN), a generative AI model, can synthesize images of distinct manufacturing processes (i.e., resistance spot welding and additive manufacturing) conditioned on different combinations of build parameters. The study also proposes a variant of the MPS-GAN that uses content loss to improve the perceptual quality and resolution of large images (256×256). The visual and numerical results all show the high capability of the MPS-GAN and MPS-GAN-IR in successfully generating images that are visually and quantitatively in accordance with the geometrical attributes of the real training datasets. These results show the premises of the MPS-GAN to be adopted as a tool for preliminary evaluation of the effect of different build parameters on the final quality of the desired manufactured product. The findings of this work also support the fact that the MPS-GAN model can be a potential alternative to experimental tests and physics-based simulation. In the future, the MPS-GAN models will be modified to account for the image-generation conditioned on build parameters spanning a wider range of values.

### Computer-Implemented System

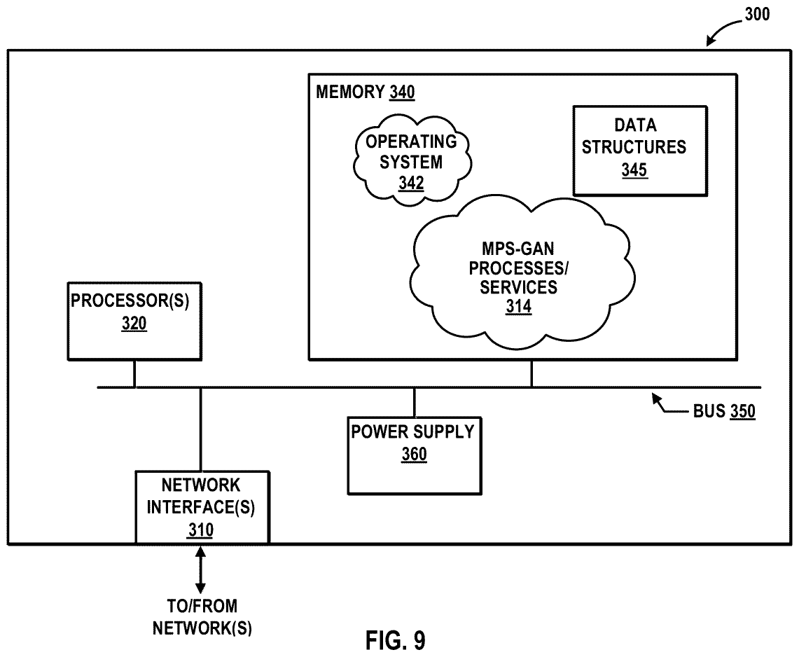

FIG. 9 is a schematic block diagram of an example device 300 that may be used with one or more embodiments described herein, e.g., as a component of the disclosed system.

Device 300 comprises one or more network interfaces 310 (e.g., wired, wireless, PLC, etc.), at least one processor 320, and a memory 340 interconnected by a system bus 350, as well as a power supply 360 (e.g., battery, plug-in, etc.).

Network interface(s) 310 include the mechanical, electrical, and signaling circuitry for communicating data over the communication links coupled to a communication network. Network interfaces 310 are configured to transmit and/or receive data using a variety of different communication protocols. As illustrated, the box representing network interfaces 310 is shown for simplicity, and it is appreciated that such interfaces may represent different types of network connections such as wireless and wired (physical) connections. Network interfaces 310 are shown separately from power supply 360, however it is appreciated that the interfaces that support PLC protocols may communicate through power supply 360 and/or may be an integral component coupled to power supply 360.

Memory 340 includes a plurality of storage locations that are addressable by processor 320 and network interfaces 310 for storing software programs and data structures associated with the embodiments described herein. In some embodiments, device 300 may have limited memory or no memory (e.g., no memory for storage other than for programs/processes operating on the device and associated caches).

Processor 320 comprises hardware elements or logic adapted to execute the software programs (e.g., instructions) and manipulate data structures 345. An operating system 342, portions of which are typically resident in memory 340 and executed by the processor, functionally organizes device 300 by, inter alia, invoking operations in support of software processes and/or services executing on the device. These software processes and/or services may include MPS-GAN processes/services 314 described herein. Note that while MPS-GAN processes/services 314 is illustrated in centralized memory 340, alternative embodiments provide for the process to be operated within the network interfaces 310, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the MPS-GAN processes/services 314 is shown as a standalone process, those skilled in the art will appreciate that this process may be executed as a routine or module within other processes.

What is claimed is:

1. A method of assessing an impact of processing parameters using a multi-conditional generative adversarial network model, comprising:
providing a generative adversarial network (GAN) comprising a generator and a discriminator, the GAN being configured to generate images representative of a manufacturing process or a manufactured product conditioned on a plurality of processing parameters;
accessing, as inputs to the GAN, a latent vector and a plurality of class labels, each class label corresponding to a respective processing parameter of the plurality of processing parameters;
converting each class label to a respective embedding representation to generate a plurality of embeddings corresponding to the plurality of class labels;
synthesizing, by the generator, a set of images including:
(i) generating an image by:
reshaping the plurality of embedding representations and the latent vector to obtain reshaped embeddings and a reshaped latent representation;
concatenating the reshaped embeddings with the reshaped latent representation; and
processing the concatenation through one or more neural network layers configured to progressively increase image dimensionality and generate the image;
(ii) outputting, by providing the generated image to the discriminator,
(a) a first output indicating whether the input image is more likely to correspond to a real image obtained from a reference dataset or an image generated by the generator, and
(b) a plurality of additional outputs, each corresponding to a different processing parameter of the plurality of processing parameters, each additional output representing an estimated likelihood for each possible value of the respective parameter, wherein a value associated with a highest likelihood is identified as the discriminator's predicted class for that parameter, such that the discriminator simultaneously assesses authenticity of the image and a combination of manufacturing conditions represented by the processing parameters in the image,
(iii) repeating steps (i)-(ii) for a plurality of iterations to generate synthesized images corresponding to candidate combinations of the processing parameters; and
identifying, based on the synthesized images, an optimal combination of the plurality of processing parameters by evaluating one or more quality measures associated with the generated images indicative of a desired manufacturing outcome.

2. The method of claim 1, wherein each class label is treated as a discrete variable with a finite set of possible values, and the discriminator is configured as a multi-class classifier that outputs, in addition to an assessment as to authenticity, separate likelihood distributions for the class values of the respective processing parameters.

3. The method of claim 1, wherein prior to image generation each class label is converted to an embedding representation and reshaped for concatenation with a reshaped latent vector for input to the generator.

4. The method of claim 1, wherein a reference real image is chosen by reading the parameter values used for the generated image, finding real images in a dataset that have the same parameter values, and selecting one or more of those real images for comparison.

5. The method of claim 1, wherein the synthesized images comprise at least one of thermal images representing resistance spot welding or X-ray computed tomography (XCT) images representing additively manufactured specimens, the images being constrained by predefined combinations of processing parameters.

6. The method of claim 1, wherein the discriminator's additional outputs for the processing parameters are used to determine the predicted class value for each parameter by selecting the value associated with the highest estimated likelihood.

7. The method of claim 1, wherein the GAN is a variation of the AC-GAN model that can generate images conditioned on multiple conditions that integrates an auxiliary classifier to discriminate between the class labels of the real and generated images instead of providing the class labels directly to the discriminator.

8. The method of claim 1, wherein evaluating the generated images to identify the optimal combination of processing parameters includes using domain-specific quality measures.

9. The method of claim 1, wherein the plurality of embeddings convert each class label of the plurality of class labels to an array of trainable parameters.

10. The method of claim 1, wherein the discriminator of the GAN is modeled as a multi-class convolutional neural network.

11. A system for assessing the impact of processing parameters on a manufacturing product, comprising:
a memory; and
a processor having access to a set of executable instructions located on the memory which, when executed, cause the processor to activate a multi-parameter simulation generative adversarial network, the multi-parameter simulation generative adversarial network comprising:
a generator module including an array of trainable parameters, wherein the generator module is operable to:
receive a plurality of input parameters and latent vectors, wherein each input parameter of the plurality of input parameters corresponds to a specific processing parameter for a manufacturing product; and
synthesize images of the manufacturing product based on the plurality of input parameters and latent vectors;
wherein the generator module synthesizes the images based on a discriminator feedback without direct access to real training image data; and
a discriminator module operable to assess the images synthesized by the generator module and return a predicted value for each input parameter of the plurality of input parameters and a determination of realness of the synthesized images, wherein the discriminator module is trained using real images;
wherein the array of trainable parameters of the generator module are updated based on the determination of realness and assessment of input parameters by the discriminator module.

12. The system of claim 11, wherein the plurality of input parameters are discrete values or labels.

13. The system of claim 11, wherein the multi-parameter simulation generative adversarial network further comprises:
a judge module configured to assess the perceptual quality of the images synthesized by the generator module by:
comparing the synthesized images to real images of a product manufactured under the same parameters as the plurality of input parameters; and
determining a content loss of the synthesized images;
wherein the array of trainable parameters of the generator module are updated according to a combination of the content loss obtained based on the judge module's assessment of the perceptual quality of the synthesized images and an adversarial and auxiliary loss obtained based on the determination of realness and assessment of input parameters by the discriminator module.

14. The system of claim 13 wherein a weighting factor is applied to the content loss.

15. The system of claim 14, wherein the content loss weighting factor is gradually increased as the multi-parameter simulation generative adversarial network is trained.

16. A computer-implemented method for improved-resolution, multi-conditional image generation to identify optimal build parameters, comprising:
providing a generative adversarial network conditioned on multiple processing parameters and configured to generate images of at least 256×256 pixels from a latent space;
for each generated image, selecting a reference real image that has the same combination of processing-parameter values as the generated image;
obtaining feature representations of the generated image and of the selected reference real image using a pre-trained external feature-extraction model that is separate from the discriminator;
computing a content-based difference between the feature representations and combining that difference with adversarial and auxiliary-classification terms in a combined loss; and
adjusting a weighting factor applied to the content-based difference during training, including using a smaller weight at early stages to learn the probabilistic distribution of the training images under the processing-parameter conditions and increasing the weight thereafter to improve perceptual quality and resolution of the generated images.

17. The method of claim 16, wherein the pre-trained external feature-extraction model is a VGG-19 network, and the content-based difference is computed as a mean-squared error between feature maps of the generated image and the selected reference real image.

18. The method of claim 16, wherein selecting the reference real image includes executing a search that retrieves images in the dataset whose labels exactly match the processing-parameter values used to generate the image, thereby ensuring that both images correspond to the same parameter combination for feature comparison.

19. The method of claim 16, wherein the weighting factor is held at a small value for an initial set of training epochs and then increased by at least an order of magnitude for later epochs to emphasize perceptual quality.

20. The method of claim 16, wherein the images comprise 256×256 X-ray computed tomography images that reflect defect morphology in additively manufactured specimens and are conditioned on scan speed and hatch spacing.
